(19) United States
(12) Patent Application Publication
(10) Pub. No.: US 2018/0165454 A1
(43) Pub. Date: Jun. 14, 2018

(54) PROTECTION OF PROGRAMS, STREAMING MEDIA AND OTHER DATA FLOWS

(71) Applicant: ARRIS Enterprises LLC, Suwanee, GA (US)

(72) Inventor: Lex Aaron Anderson, Auckland (NZ)

(21) Appl. No.: 15/374,590

(22) Filed: Dec. 9, 2016

(51) Int. Cl. G06F 21/57

(52) U.S. Cl. CPC G06F 21/572; G06F 2221/033; G06F 21/577

(57) ABSTRACT

A method is provided to generate a protected program from an original program such that the protected program is less vulnerable than the original program to unauthorised use when installed on a device. The method includes: receiving, at a processor, an original program, wherein the original program takes an input data flow and generates an output data flow. The processor then transforms the original program into a white-box implementation of the original program including encoded functional blocks, and then transforms the white-box implementation of the original program into a node-locked program by further encoding the encoded functional blocks of the program with device specific parameters to provide node-encoded functional blocks, wherein the node-locked program is for use on and is node-locked to the device.

### BACKGROUND

### Technical Field

Embodiments described relate to node-locking a program to protect a program and resultant data flows. The embodiments could be used in streaming media and/or other data flow systems to protect programs and/or data flows against unauthorized use when intercepted.

### Related Art

In computer systems, input data flows are processed by program code that defines Algorithms/programs with functionality to generate output data flows. For example, a program might decrypt incoming encrypted data flows using a key to generate outgoing data flows that are decrypted. Encrypting incoming data flows prevents unauthorised consumption of the data flows and/or their content. A user must have the appropriate program and keys to decrypt and consume the incoming data flows and content. Consumption of the data flows means very generally any sort of use, such as viewing, copying or otherwise using the data flows and/or the content therein.

Examples of systems that implement such programs are: 1. Streaming media delivery systems that deliver encrypted media content, which is received by a media player including a program that decrypts the media stream and outputs the media content. 2. Document management systems, where documents are shared between authorized parties. 3. Media or software license management, where verification of licenses is required. 4. Media players in a web browser or other untrusted platform. 5. More generally, a data flow receiver that receives a stream of encrypted data and contain a program to decrypt that stream to provide unencrypted output, or any system on an untrusted platform where the program needs protection from untrusted parties.

In such computer systems with these programs, it is possible for an unauthorised user to attack the system to consume the incoming data flows and/or content. For example, using key recovery, reverse engineering, code lifting and/or clone attacking, it is possible for an unauthorised user to generate unencrypted data flows from the encrypted incoming data flows to consume the content.

### SUMMARY

It is an object of the invention to provide or use program that is node-locked.

In one aspect the present invention can comprise a method of generating a protected program from an original program such that the protected program is less vulnerable than the original program to unauthorised use when installed on a device, the method comprising the steps of: receiving, at a processor, an original program that provides a functionality, wherein the original program takes an input data flow and generates an output data flow, in the processor: transforming the original program into a white-box implementation of the original program comprising encoded functional blocks, and transforming the white-box implementation of the original program into a node-locked program, by further encoding the encoded functional blocks with device specific parameters to provide node-encoded functional blocks, wherein the node-locked program is for use on and is node-locked to the device.

Optionally the node-locked program is a node-locked white-box implementation of the original program.

Optionally the original program further takes an input key and generates the output data flow from the input data flow and the key.

Optionally the node-locked program is generated on a processor on the device, or is generated elsewhere for transferring, or storing for later transfer from the processor to the device.

Optionally the white-box implementation of the original program is a static white-box implementation of the original program.

Optionally the static white-box implementation of the original program is application bound to an application on the device on which the node-locked program will execute.

Optionally the white-box implementation of the original program is a dynamic white-box implementation of the original program.

Optionally the dynamic white-box implementation of the original program is application bound to an application on the device on which the node-locked program will execute.

Another aspect the present invention can comprise a system for generating a protected program from an original program such that the protected program is less vulnerable than the original program to unauthorised use when installed on a device, the system comprising a processor for: receiving an original program that provides a functionality, wherein the program takes an input data flow and generates an output data flow, transforming the original program into a white-box implementation of the original program code comprising encoded functional blocks, and transforming the white-box implementation into a node-locked program, by further encoding the encoded functional blocks with device specific parameters to provide node-encoded functional blocks, wherein the node-locked program is for use on and is node-locked to the device.

Optionally the node-locked program is a node-locked white-box implementation of the original program.

Optionally the original program further takes an input key and generates the output data flow from the input data flow and the key.

Optionally the device is or forms part of the system.

Optionally the system is configured to transfer, or store for later transfer, the node-locked program from the processor to the device.

Optionally the white-box implementation of the original program is a static white-box implementation of the original program.

Optionally the static white-box implementation of the original program is application bound to an application on the device on which the node-locked program will execute.

Optionally the white-box implementation of the original program is a dynamic white-box implementation of the original program.

Optionally the dynamic white-box implementation of the original program is application bound to an application on the device on which the node-locked program will execute.

### BRIEF DESCRIPTION OF THE DRAWINGS

Further details of the present invention are explained with the help of the attached drawings in which:

FIG. 1 shows a computer system executing a program (e.g. for processing a data flow), and a computer system executing a node-locked version of the program with the same functionality but which is node-locked to the system.

FIG. 2 shows a computer system that is configured to node-lock a program.

FIG. 3 is a flow diagram showing the steps of program node-locking.

FIG. 4A is a block diagram showing the functional representation of an original algorithm, and a static white-box implementation without application binding of the original program.

FIG. 4B is a block diagram showing the functional representation of an original algorithm, and a dynamic white-box implementation without application binding of the original algorithm.

FIG. 5A is a block diagram showing application binding for a static white-box implementation.

FIG. 5B is a block diagram showing the functional representation of an original algorithm, and a static white-box implementation with application binding of the original algorithm.

FIG. 5C is a block diagram showing application binding for a dynamic white-box implementation.

FIG. 5D is a block diagram showing the functional representation of an original algorithm, and a dynamic white-box implementation with application binding of the original algorithm.

FIG. 6A is a block diagram of a node-locking framework for a static white-box implementation (with or without application binding) of an original program.

FIG. 6B is a block diagram of a node-locking framework for a dynamic white-box implementation (with or without application binding) of original program.

FIG. 7A is a block diagram showing the functional representation of a static white-box implementation (without application binding) of an original algorithm, and a node-locked version of the static white-box implementation.

FIG. 7B is a block diagram showing the functional representation of a static white-box implementation (with application binding) of an original, and a node-locked version of the static white-box implementation.

FIG. 7C is a block diagram showing the functional representation of a dynamic white-box implementation (without application binding) of an original algorithm, and a node-locked version of the dynamic white-box implementation.

FIG. 7D is a block diagram showing the functional representation of a dynamic white-box implementation (with application binding) of an original algorithm, and a node-locked version of the dynamic white-box implementation.

FIG. 8 shows a system that processes input data streams and generates output data streams using a node-locked program.

FIG. 9 shows a prior art streaming media delivery system.

FIG. 10 shows in a first embodiment a streaming media (delivery and reception) system that utilizes a program for processing data flows.

FIG. 11 shows a media server of the streaming media system in more detail.

FIG. 12 shows a media player of the streaming media system in more detail.

FIG. 13A is a flow diagram showing one embodiment of a method for node-locking a static white-box implementation original program (without application binding).

FIG. 13B is a flow diagram showing another embodiment of a method for node-locking a static white-box implementation original program (with application binding).

FIG. 13C is a flow diagram showing another embodiment of a method for node-locking a dynamic white-box implementation original program (without application binding).

FIG. 13D is a flow diagram showing another embodiment of a method for node-locking a dynamic white-box implementation original program (with application binding).

### DETAILED DESCRIPTION

### 1. General Overview

Embodiments described herein use a combination of white box implementations and node locking of the program to inhibit a user from unauthorised consumption of data flows and their content (hereinafter “content”). By inhibit, it means the embodiments at least overcome or slow down an adversary trying to consume data flows.

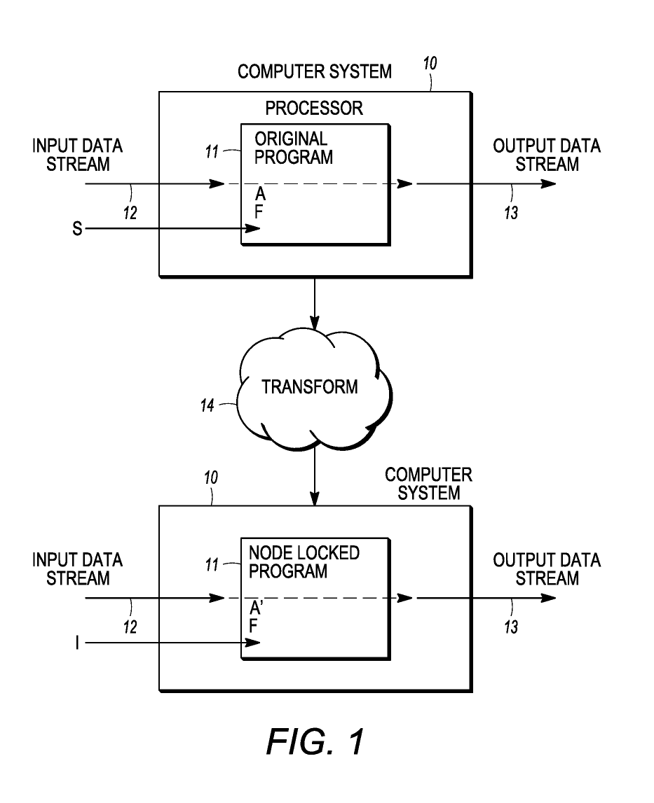

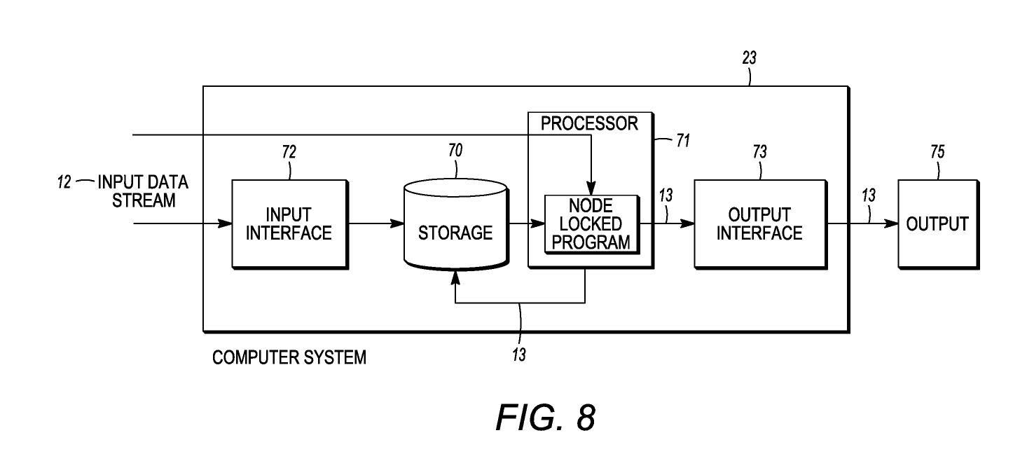

As an example (referring to the top half of FIG. 1, and to be described further later in respect of FIGS. 8 to 13D), in a streaming media delivery system, a media server delivers media content in encrypted and compressed media streams to subscribers (end users) who wish to view the media content. The subscriber's media player 10 receives a media stream (embodying media content) as input data flow and has a program embodying algorithms/functionality to process the media stream (including decrypting and decompressing the media stream/input data flow) to generate decrypted and decompressed output data flows embodying the media content that can be delivered to an audio-visual system for the user to view the media content. The algorithm also takes a key as an input. The media stream is encrypted to prevent unauthorized parties (i.e. nonsubscribers) being able to view the media content, even if they can intercept the media stream prior to arriving at the media player.

More particularly, the top half of FIG. 1 shows a computer system 10 with a processor 11 that executes an original program that embodies the algorithm A. The functionality F of the algorithm A takes an input data stream (input data flow) 12 and key S as an input and generates an output data stream (output data flow) 13. The computer system could be a media player or any other data flow receiver, for example. As an example, the algorithm A could have a decryption functionality that takes an encrypted data stream that embodies content and decrypts it using the key S to provide an unencrypted output data stream containing the content in a form that can be displayed to a user.

Such a system is vulnerable to attack, as described above. For example, a key recovery attack enables an adversary to generate the unencrypted output data stream.

Embodiments described herein will be focused on streaming media delivery systems, although embodiments can be applied to other applications such as those listed above.

### 2. Node Locking a Program to Improve Resilience Against an Attacker

### 2.1 Overview of Embodiment

FIG. 1 shows conceptually what the embodiments described herein provide. In overview, referring to FIG. 1, in one embodiment an original program (defined or written in or by program code) embodying an original algorithm “A” with original functionality “F” is transformed into node locked program—being a white-box node-locked implementation of the original program. The original program executes the original algorithm, which takes an (encrypted) input data flow (also termed “input data stream”) and a key S, and generates an (unencrypted) output data flow (also termed “output data stream”). The resultant node locked program executes a different algorithm, but it still can take the (encrypted) input data flow and generate an (unencrypted) output data flow, along with taking other inputs, I, such as device specific inputs/parameters, application specific inputs, and/or a dynamic key—depending on the embodiment. The original program and node-locked program embody data flow programs. The node-locked program according to embodiments herein, can be termed a “protected program.”

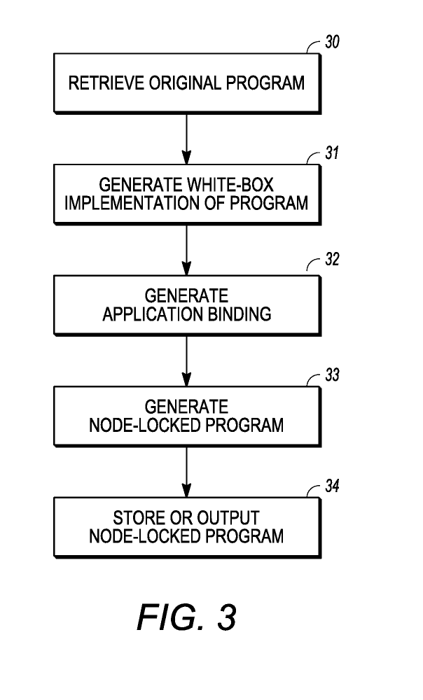

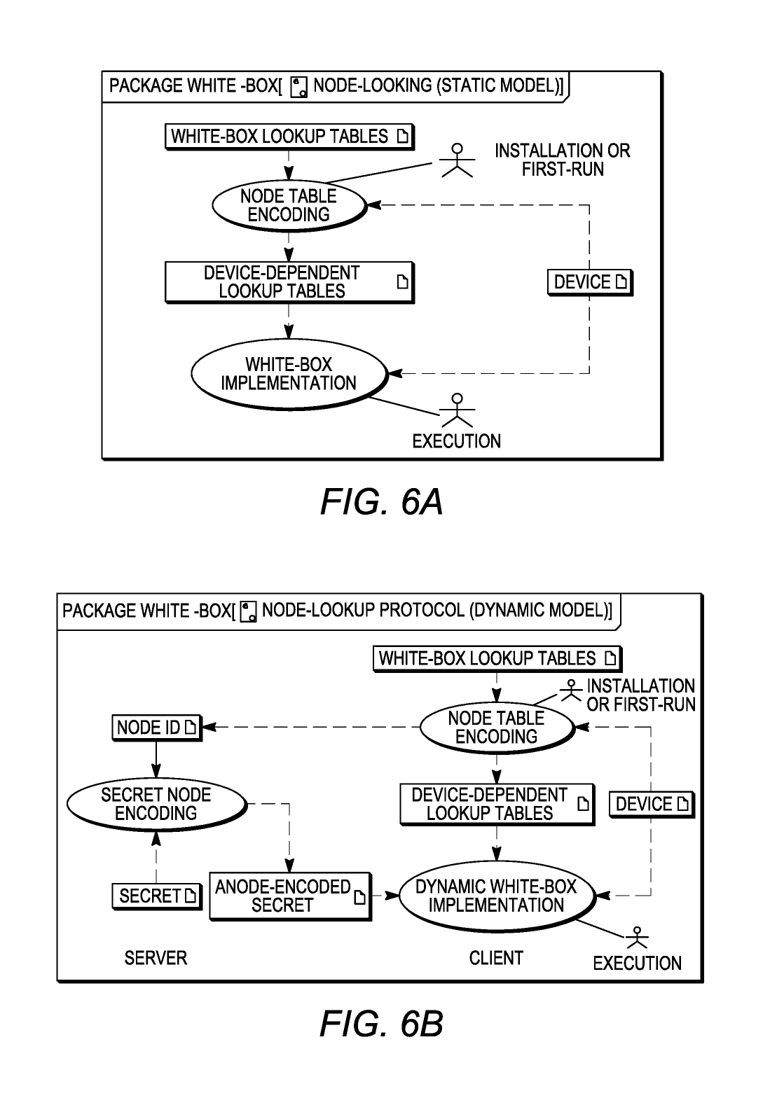

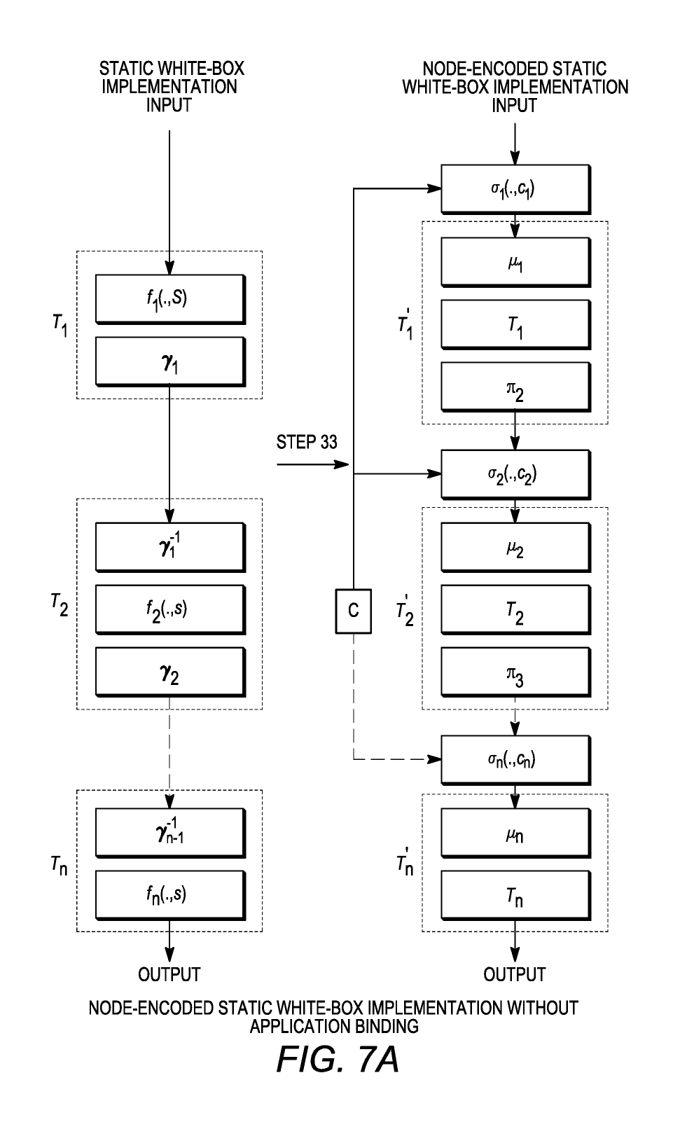

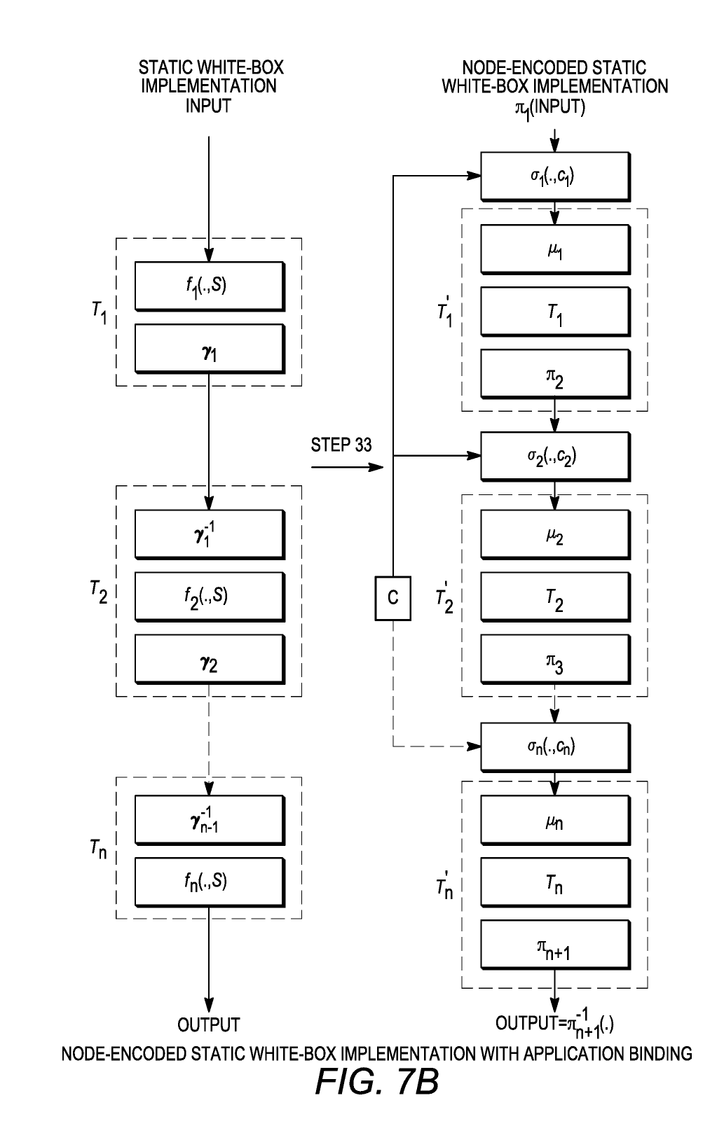

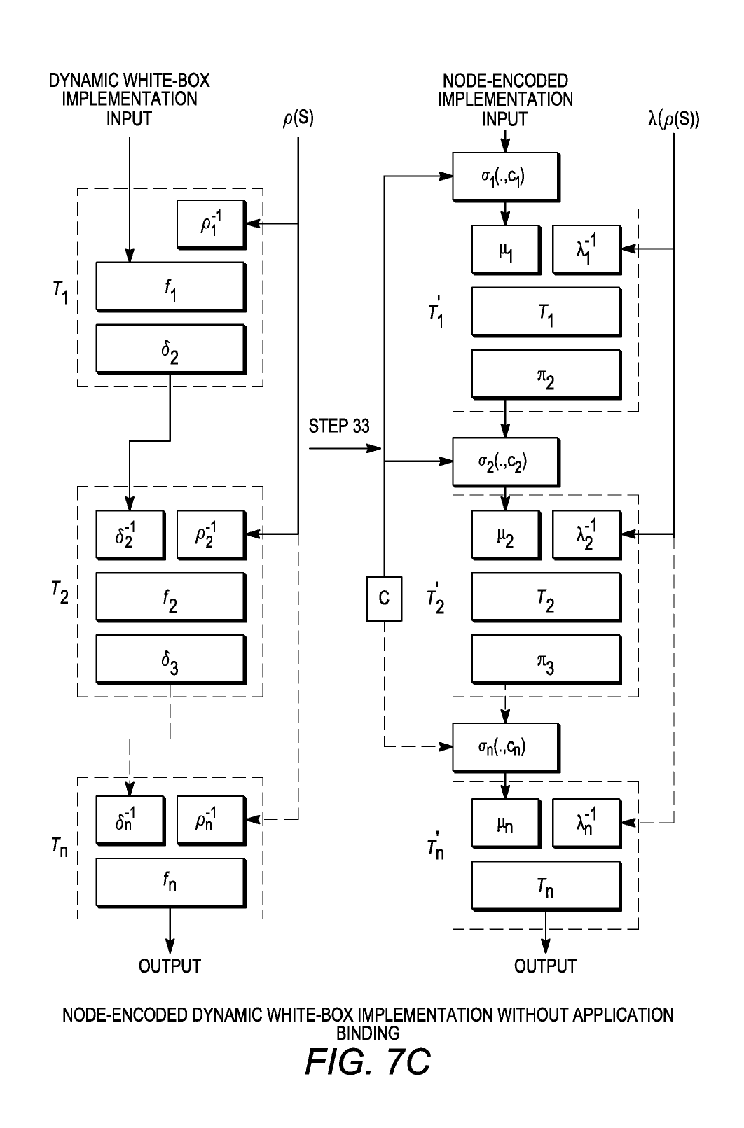

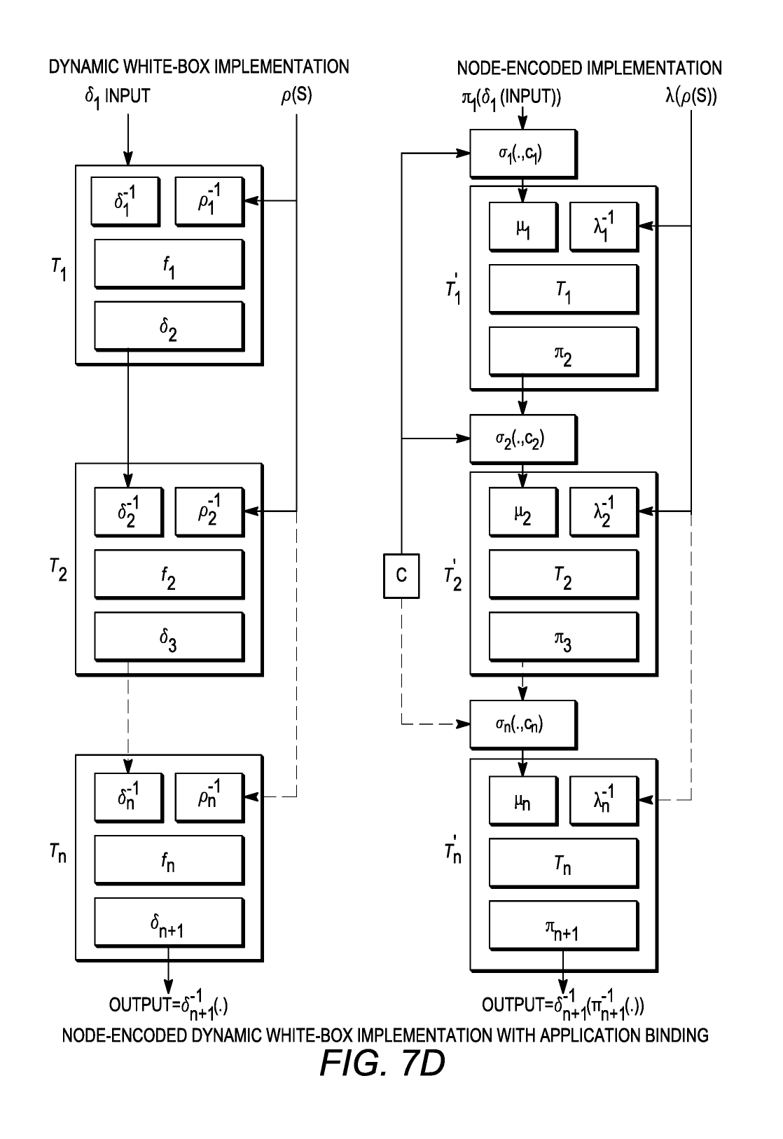

To generate the protected program, first the original program is converted/transformed into a white box implementation (either static or dynamic) such as shown and described with reference to FIGS. 3, 4A, 4B, and 5A to 5D. The white-box implementation of the program (WBI program) is then node-locked to the particular device on which the program will be executed, such as shown and described with reference to FIGS. 6A, 6B, 7A, 7B, 7C, 7D. This results in a node-locked, white box program—or more simply “node-locked program”. For example, the device could be a media player or any other computer system which is processing data flows with the program. Optionally, before node-locking the WBI program, the WBI program could undergo application binding, so that the WBI program is application bound. The application could be any suitable application on the device on which the WBI program executes, such as a media player, operating system or other platform. The top computer system of FIG. 1 shows the original program operates on a computer system (such as a data flow receiver like a media player) and its functionality generates an output data stream (data flow) from an input data stream (data flow). The program is vulnerable to attack. The bottom computer system of FIG. 1 shows the node-locked program operating on the same computer system. It (and its content nd data flows) is less vulnerable to attack, as described above.

A white box implementation of original program prevents, or at least slows down, an adversary from making a key recovery attack. This is because the key is formed as part of the white box implementation of the program, or an encoded static or dynamic key is used. A white box implementation of a program can still be vulnerable to a code lifting attack. Node-locking the WBI program to a particular device prevents, or impedes an adversary, from carrying out a code-lifting attack. In such a situation, it might still be possible for an adversary to code-lift the WBI program and the application it executes on. In this case, the option of also carrying out application binding of the WBI program to the application it executes on prevents, or at least slows down, an adversary from code-lifting the WBI program with the application.

### 2.2 Generating White-Box Node-Locked (Protected) Program

### 2.2.1 Overview of Node-Locked Program Generation

The process of generating a node-locked program from an original program according to a first embodiment will now be described in detail with reference to FIGS. 1, 2 and 3.

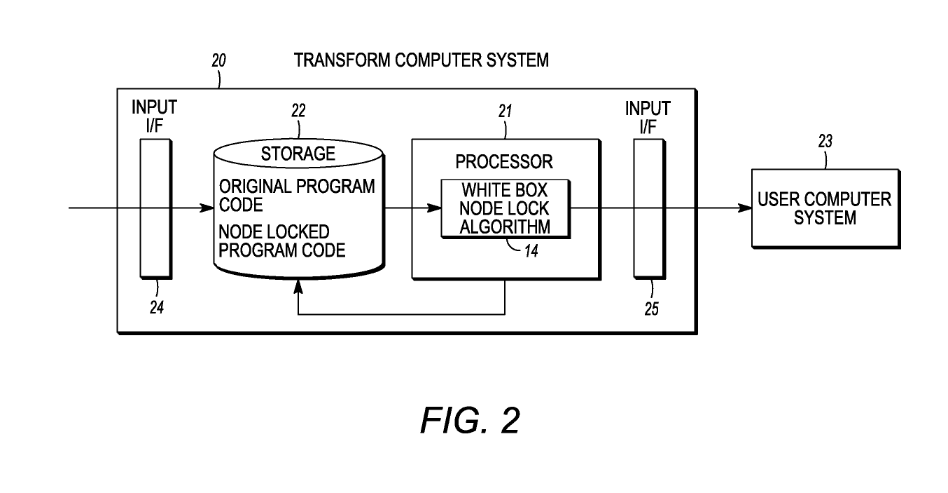

Referring to FIGS. 2 and 3, the protected program generation method is undertaken on a computer system 20 that has an input 24 and/or storage repository 22 with the original program (defined or written in or by program code) to be protected and a processor 21. The processor 21 is configured with a program that when executed takes the original program as input and carries out the generation of a node-locked version of the program, as described below. In particular, it executes a program protection algorithm that: a) generates a white box implementation of the original program (resulting in a WBI program), (which optionally comprises generating an optional application binding of that WBI program), and b) carries out node-locking, which results in a node locked (WBI) implementation of the original program (called a node-locked program or alternatively a protected program). The white box implementation (with or without application binding) of the original program comprises generating tables that provide the WBI program functionality. Similarly, the node-locked implementation of the WBI program comprises generating tables that provide the node-locked program functionality. Details of tables and their generation are described in detail below. Reference herein to node-locked implementation of the original program is taken to mean that there is a node-locked implementation of a white box implementation (and optional application binding) of the original program.

Referring to the steps in FIG. 3, the original program to be protected is taken from the input and/or the storage repository 22, step 30, and passed to the processor 21 that runs the program protection algorithm 14. The program protection algorithm 14 first creates a white box (either static or dynamic) implementation of the original program, step 31.

In one option, a static white-box implementation of the original program is generated. Static white-box implementations. can be vulnerable to code-lifting attacks, where the attacker does not attempt to extract the secret key from the white-box implementation, but instead uses the entire implementation as a “big key”. This is possible because the secret key is “embedded” in the static white-box implementation itself. Under such an attack, the white-box implementation is not being reverse-engineered, but instead its code is “lifted” so as to utilize its functionality.

Therefore, while a static white-box implementation can be used, for additional security, preferably (but optionally) a dynamic white-box implementation is generated and used instead.

In the case of dynamic white-box implementations, code-lifting attacks alone will not accomplish the same goal. The encoded secret key must also be extracted from an authorized implementation and injected into the lifted white-box implementation. The goal of well-designed white-box implementations and protocols is to make any such attacks non-trivial:

Definition 1. Well-designed dynamic white-box properties:

1. Diversity. Dynamic white-box implementations are diverse if each implementation subset is unpredictably different from any other; where each diverse subset of instances utilize distinct white-box encodings.

2. Application binding. The calling application is tightly coupled to (mutually dependent on) the dynamic white-box implementation.

3. Device binding. Use of multiple-encryption to bind dynamic white-box secrets to a device instance. This technique is often referred to as a keyladder.

4. Protocol binding. Key delivery and other cryptographic protocols (ideally with attack detection and revocation), use persistent security tokens bound to the dynamic white-box implementation.

Once a WBI (static or dynamic) program is generated, it can then undergo an optional application binding, whereby the WBI program further transformed/converted so it is bound to the application it executes on, such as a media player, step 32. Application binding of the WBI program is not essential, but is preferred.

Next, the algorithm node-locks the white box implementation of the program (either with application binding or without application binding) to the device on which the node-locked program will be executed, step 34. This is also called “device binding”. The node-locking provides a node-locked program, which in one example can take an input stream containing the original content and provide an output data stream for consumption of the original content, but is less vulnerable to attack.

The combination of node-locking a white-box implementation (optionally with application binding) of an original program provides additional security. The traditional view of node-locking revolves around the generation of a node license. When the node-locked program is executed, the license data is validated against information gathered from the device. The application may then take appropriate action, such as terminating with an error if the verification fails.

This traditional model is weak in a white-box attack context, where the attacker has full access to and control over the target device:

1. Device information can be cloned or node-identification can be cracked to return a known device identification that is compatible with an intercepted or phony node-license.

2. Lock verification can likewise be cloned, cracked or bypassed entirely to allow unlicensed programs to run on any device.

Since a white-box implementation is almost entirely composed of encoded lookup-tables, the present inventor determined that the application of additional device-dependent encodings to these tables achieves a robust form of node-locking, where the entire white-box implementation acts as both node-license and license verification:

1. Node identification is embedded in every white-box operation, necessitating an “all-or-nothing” attack on the node-encoded implementation. Since there are no single points where device identification and node verification occur, an attack must be levied against all components of the white-box implementation.

2. Node verification is replaced by a silent failure mode that does not rely on conditional logic, where any small differences in device configuration, errors induced by tampering or input manipulation will cause the white-box implementation to output corrupted data in an unpredictable manner, consistent with the avalanche effect.

3. Arbitrarily large device configuration information to thwart cloning attacks.

Herein, a node-locking construction for static white-box implementations is shown, then it is shown how this can be extended for dynamic white-box implementations.

The node-locked program can then be stored in the repository 22 for later retrieval and use and/or transfer via output interface 25 to another computer system 23 (that is, a data flow receiver such as a media player) for use, step 32. Alternatively, it can be generated on the computer system 23 it is to be used on. The computer system using the node-locked program could be the one shown in FIG. 1, 8 or 12 for example.

Each stage of FIG. 3 will now be described in more detail.

### 2.2.2 Generating White-Box Implementation of Original Program

As noted above, one part of the program protection algorithm executing on the controller comprises generating a white-box implementation of the original program (“white-box program”). This could either be a static white-box implementation or a dynamic white-box implementation.

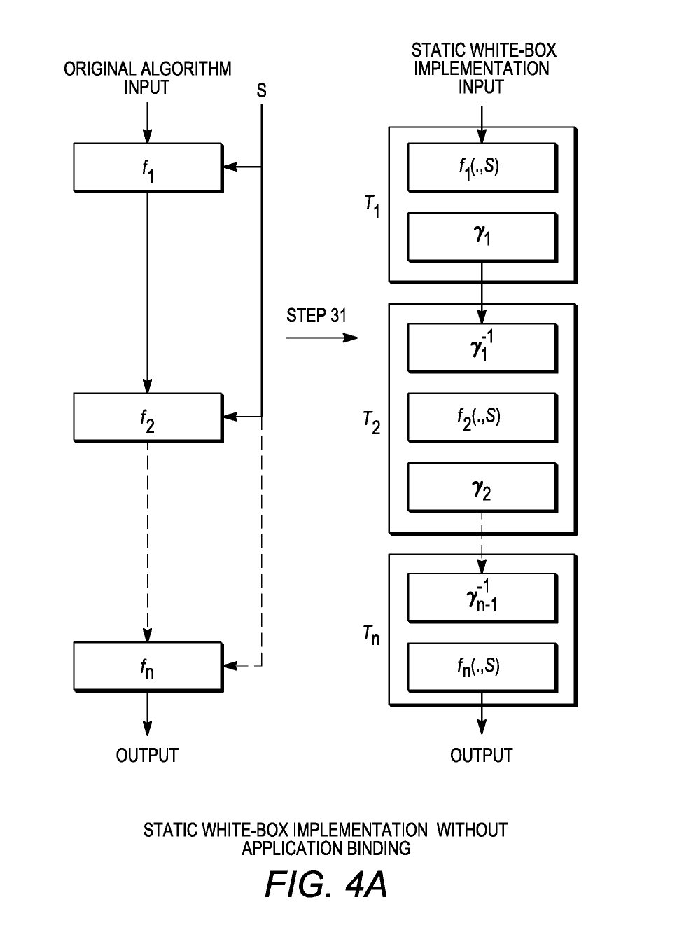

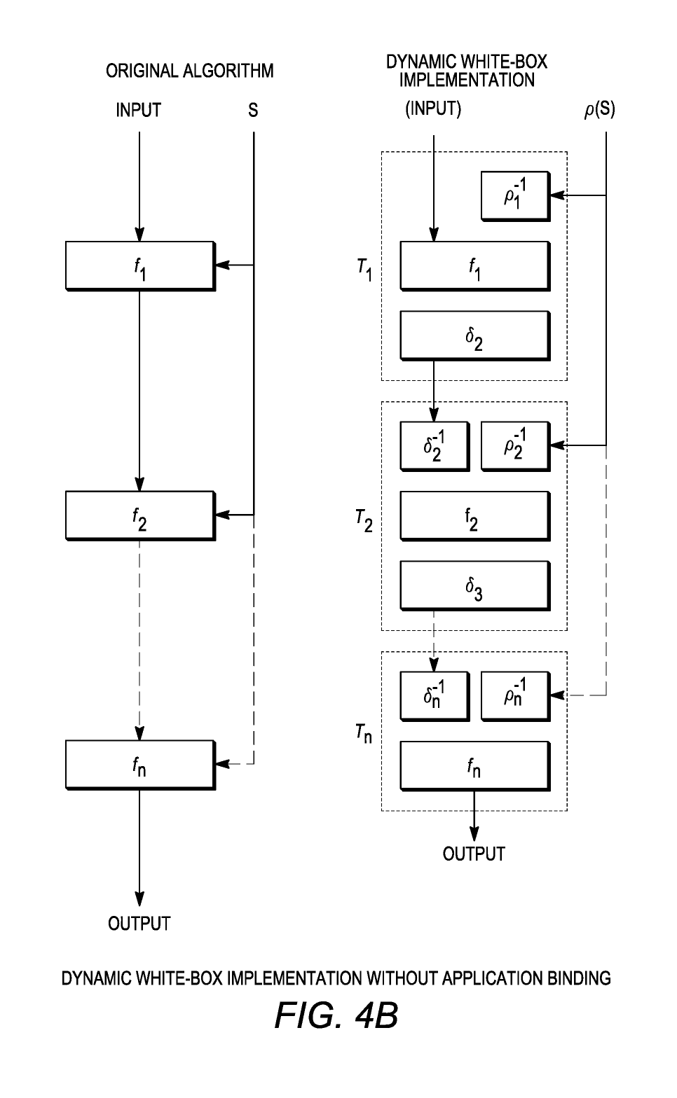

Referring to FIG. 4A and FIG. 3, the generation of a (static) white-box implementation (without application binding) of the original program will be described. Original program comprises functions/operations f₁, f₂, . . . , fₙ in an original algorithm (left hand side of FIG. 4A) along with a fixed secret S (such as a key). The program takes (encrypted) input data flows and secret key S and uses those inputs to generates (decrypted) output data flows. The (static) white-box implementation of the original program is generated by taking the functions f₁, f₂, . . . , fₙ and the secret key S and encoding them as a lookup-table T₁, T₂, . . . , Tₙ in the static white-box implementation of that algorithm (defined by the original program code) (right hand side of FIG. 4). The encodings are generated as a sequence of random bijections, γ₁, γ₂ . . . , γₙ₋₁.

This provides some degree of protection but is still vulnerable to code-lifting attacks, as previously noted. As an alternative, and referring to FIG. 4B and FIG. 3, a dynamic white-box implementation (without application binding) of the original program could be generated instead. In this process, the original program has functions/operations f₁, f₂, . . . , fₙ in an original algorithm, each of which is encoded as a lookup-table T₁, T₂, . . . , Tₙ in the dynamic white-box implementation of that algorithm (original program). The encodings are generated a sequence of random bijections, ρ₁, ρ₂, . . . , ρₙ that are applied to the inputs and output of each operation, where ρ(S) represents an encoded secret (e.g. a secret key), which is provided dynamically to the white-box implementation.

### 2.2.3 Application Binding

As described above, optional additional protection can be provided by application binding the WBI (static or dynamic) program. Application binding is a method for tightly coupling the calling application (such as a media player or other DRM application) with the WBI program executing on the application. This pushes the WBI program boundaries into the calling application so neither the WBi program nor the calling application can operate independently. In this case, the generation of the WBI program also includes the use of external codings to achieve the binding. Application binding occurs as part of the WBI program generation process.

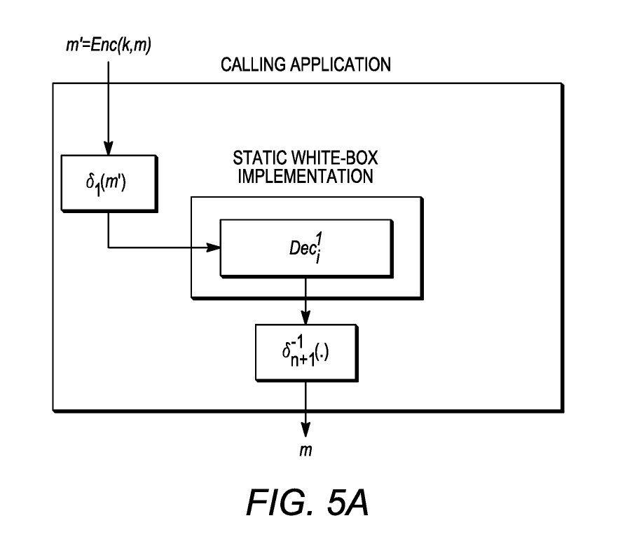

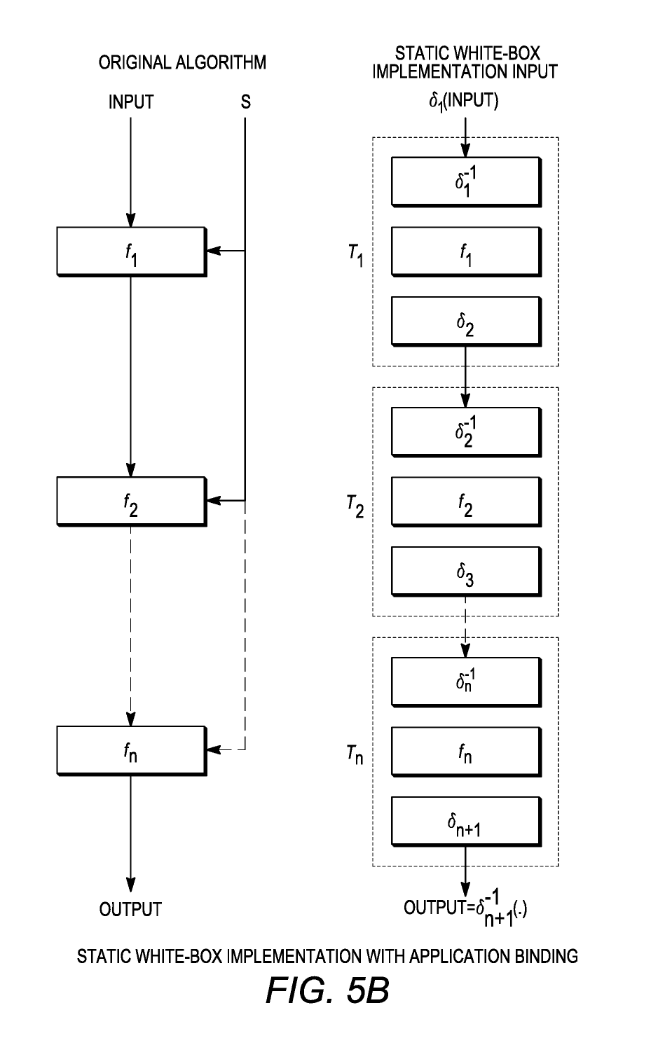

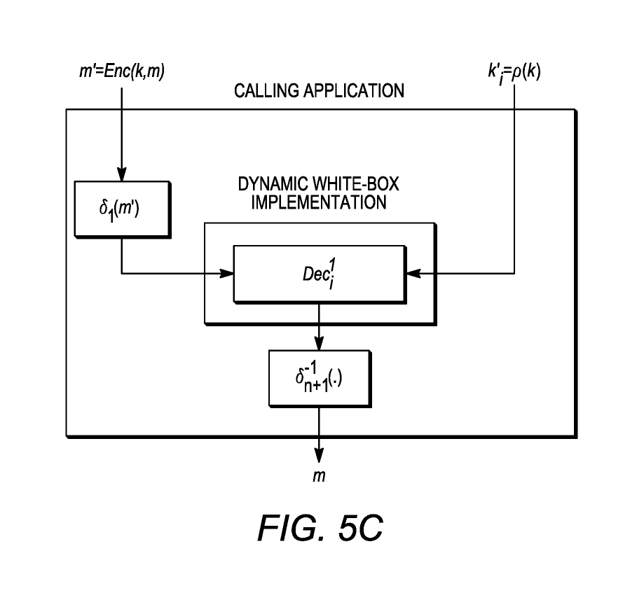

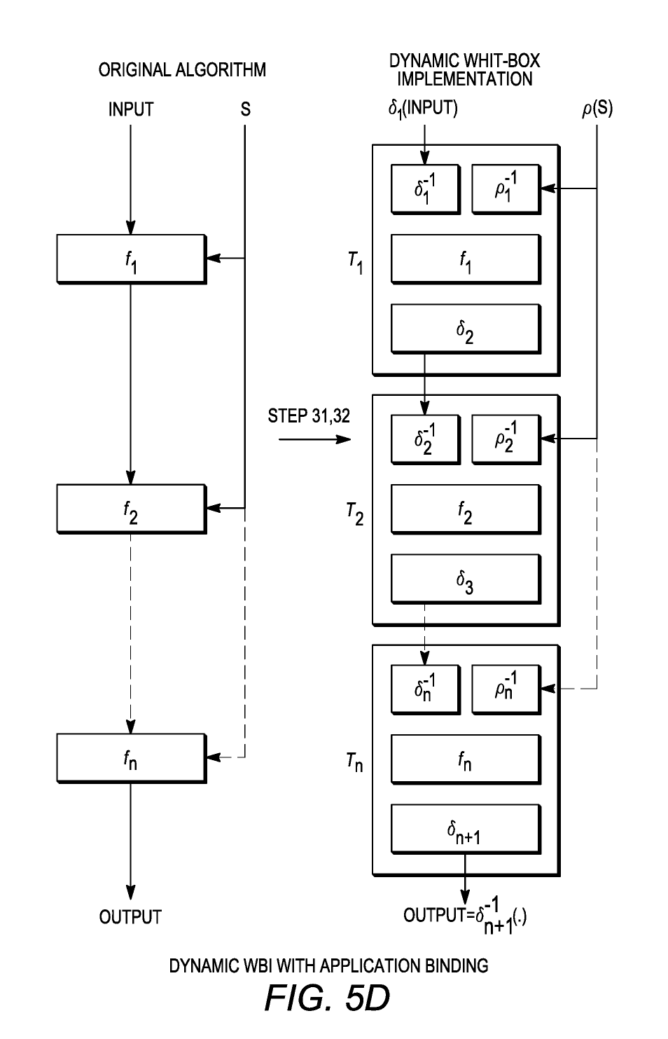

Referring to FIG. 5A, 5B and FIG. 3, the generation of a (static) white-box implementation of the original program with application binding will be described.

FIG. 5A shows the actions for generating a static white-box implementation with application binding. The white-box implementation usually takes the input (e.g. input data stream) m′. However, in application binding, the white-box implementation tables are generated to take as an input a random bijection δ₁(m′), where δ₁(m′) takes m′ and parameters from the calling application as input to generate the random bijection, resulting in the white box implementation shown in FIG. 5B. Here, original program code comprises functions/operations f₁, f₂, . . . , fₙ in an original algorithm (left hand side of FIG. 5B) along with a fixed secret S (such as a key). The program takes (encrypted) input data flows and secret key S and uses those inputs to generate (decrypted) output data flows. The (static) white-box implementation of the original program is generated by taking the functions/operations f₁, f₂, . . . , fₙ and the secret key S and encoding them as a lookup-table T₁, T₂, . . . , Tₙ in the static white-box implementation of that algorithm (defined by the original program) (right hand side of FIG. 5B). The encodings are generated as a sequence of random bijections, δ₁, δ₂, . . . , δₙ₊₁ that are applied to the inputs and outputs of each operation. The bijections δ₁ and δₙ₊₁¹ are referred to as external encodings and are used to bind the WBI program to the calling application.

FIG. 5C shows the actions for generating a dynamic white-box implementation with application binding. The white-box implementation usually takes the input (e.g. input data stream) m′. However, in application binding, the white-box implementation tables are generated to take as an input a random bijection kᵢ′=ρ(k) where ρ(k)=ρ(S) is a dynamic key, and a random bijection δ₁(m′), where δ₁(m′) takes m′ and parameters from the calling application as input to generate the random bijection, resulting in the white box implementation shown in FIG. 5D. Here, Referring to FIG. 5D and FIG. 3, a dynamic white-box implementation of the original program with application binding could be generated instead, in accordance with methods know to those skilled in the art. In this process, the program has functions/operations f₁, f₂, . . . , fₙ in an original algorithm, each of which is encoded as a lookup-table T₁, T₂ . . . , Tₙ in the dynamic white-box implementation of that algorithm (original program) and encodings. The encodings are generated as two sequences of random bijections, δ₁, δ₂, . . . , δₙ₊₁ and ρ₁, ρ₂, . . . , ρₙ that are applied to the inputs and output of each operation, where ρ(S) represents an encoded secret (e.g. a secret key), which is provided dynamically to the white-box implementation. The bijections δ₁ and δₙ₊₁¹ are referred to as external encodings and relate the application.

### 2.2.4 Node Locking the White Box Version of the Original Program

Next, the program protection algorithm comprises generating a node-locked version of the (either static or dynamic) white-box implementation program (which itself may have optional application binding, as described above). This creates the node-locked program (being a white-box, node-locked implementation of the original program).

It should be noted that node-encoding can provide a node-encoded program with or without application binding, irrespective of whether the white-box implementation has application binding or not. For example:

1. A static white-box implementation without application binding can be turned into a node encoded static white-box implementation with application binding, or alternative without application binding.

2. A static white-box implementation with application binding can be turned into a node encoded static white-box implementation with application binding, or alternative without application binding.

3. A dynamic white-box implementation without application binding can be turned into a node encoded static white-box implementation with application binding, or alternative without application binding.

4. A dynamic white-box implementation with application binding can be turned into a node encoded static white-box implementation with application binding, or alternative without application binding.

Some of the alternatives are detailed below. It will be appreciated that those skilled in the art will be able to generate any alternatives above based on the teachings herein.

2.2.5 Node-Locking Static White-Box Implementation Original Program (without Application Binding)

As described above, in one option, a static white-box implementation of original program (without application binding) is used. Referring to FIGS. 6A and 7A, the node-locking of static white-box implementation (without application binding) of the original program will be described. This generates a node-locked program (that is, a (static) white-box implemented, node-locked program).

FIG. 6A shows in diagrammatic form the structure of the node-locking for a static white-box implementation of an original program without application binding. A node-table encoding process takes the tables T₁ to Tₙ generated as part of the white-box implementation and encodes them with parameters from the device on which the node-locked program will be executed. This results in device dependent tables, which are used as the tables in the node locked white box implementation of the original program.

Referring to FIG. 7A, the node-locked program as described above is constructed as follows. (Note, FIG. 7A shows in block-level functional form the static white-box implementation (without application binding) of the original program implementing the original algorithm (left hand side) from FIG. 4A and in block-level functional form the resulting node-locked version of the white-box implementation of the original program/algorithm (right hand side)). The generation process described with reference to FIG. 3, step 33, generates the right hand side from the left hand side.

Referring to the left hand side of FIG. 7A, let iϵI be a white-box implementation instance with encoded lookup-tables T₁, . . . , Tₙ, each with symbols in a non-empty, finite alphabet T=(0, 1, . . . , m−1) and let N=(1, . . . , r) for some r≥m! then let C=(c₁, c₂, . . . , cₙ)ϵNⁿ be a configuration vector that uniquely identifies a device instance (e.g. media player or other device the node-locked program will execute on). Let Σ be the set of all surjective functions from N to S_{T}, where S_{T} denotes the set of permutations of T.

For example, for a white-box implementation with n lookup-tables, each device stores n indices cj in the range 1≤cj≤m!≤r. For m=256, suppose the implementation has n=123 lookup-tables, then the lower-bound storage for C on each device is 123×log₂ (256!)=123×210 bytes, or 26 Kb.

The right hand side of FIG. 7A shows the node-encoded (that is, node-locked) static white-box implementation (without application binding). Random bijections μ₁, μ₂, . . . , μₙ, π₁, π₂, . . . , πₙ₊₁ϵST and functions σ₁, σ₂, . . . , σₙϵΣ are generated so that for each coordinate cⱼ of C and all inputs x, it holds that μⱼ (σⱼ(πⱼ(x),cⱼ))=x, where the external encodings π₁ and π⁻¹ₙ₊₁ are introduced to bind the white-box implementation to the calling application; and each table T₁, . . . , Tₙ is replaced (as illustrated on the right-hand-side) with node-encoded tables T′₁, . . . , T′ₙ to bind the white-box implementation to the device instance, identified by C.

Referring to the pseudocode below, the node-locked program to carry out the function as represented in FIG. 7A and described above is generated in step 33, FIG. 3, as follows. This pseudocode represents program code in the controller that is configured to carry out the process.

ALGORITHM 1 UNIFORM PPT STATIC WHITE-BOX NODE-
LOCKING ALGORITHM WITHOUT APPLICATION BINDING.

| REQUIRE: {T₁,...,Tₙ}, m, n | | |
|---|---|---|
| 1: | πₙ₊₁ ← e | SET OUTPUT NODE-ENCODING TO IDENTITY PERMUTATION (130) |
| 2: | FOR EACH n ≥ j ≥ 1 DO | |
| 3: | Cⱼ ← N | GET AN ARBITRARY CONFIGURATION SAMPLE (131) |
| 4: | IF j = 1 THEN | |
| 5: | μ₁ ← e | SET TO IDENTITY PERMUTATION (132) |
| 6: | ELSE | |
| 7: | μⱼ ← S_{T} | GET RANDOM PERMUTATION (133) |
| 8: | END IF | |
| 9: | σⱼ ← Σ | SELECT A RANDOM σⱼ ϵ Σ (134) |
| 10: | πⱼ⁻¹ ← μⱼ o σⱼ (cⱼ) | COMPUTE πⱼ BY COMPOSITION (135) |
| 11: | FOR EACH 1 ≤ i ≤ m DO | |
| 12: | [Tⱼⁱ]ᵢ : = πⱼ₊₁ ([Tⱼ] μⱼ(i)) | APPLY μⱼ AND πⱼ₊₁ TO Tⱼ(136) |
| 13: | END FOR | |
| 14: | END FOR | |
| 15: | RETURN {T₁ⁱ,...,Tₙⁱ}, {σ₁,...,σₙ } , C = { c₁,...,cₙ } , π₁ , πₙ₊₁⁻¹ | |

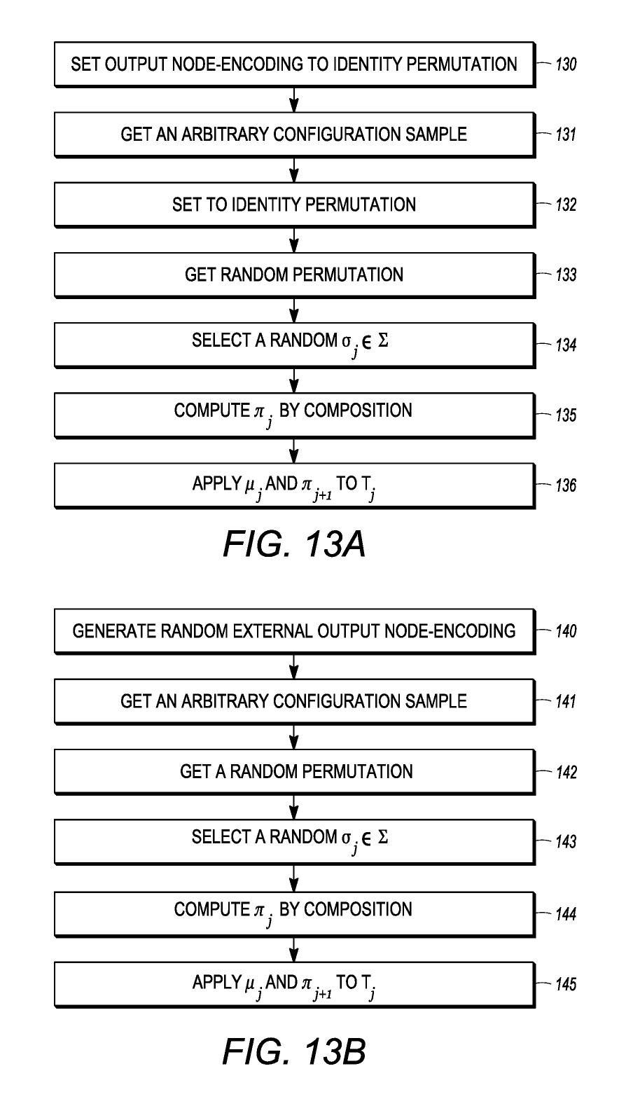

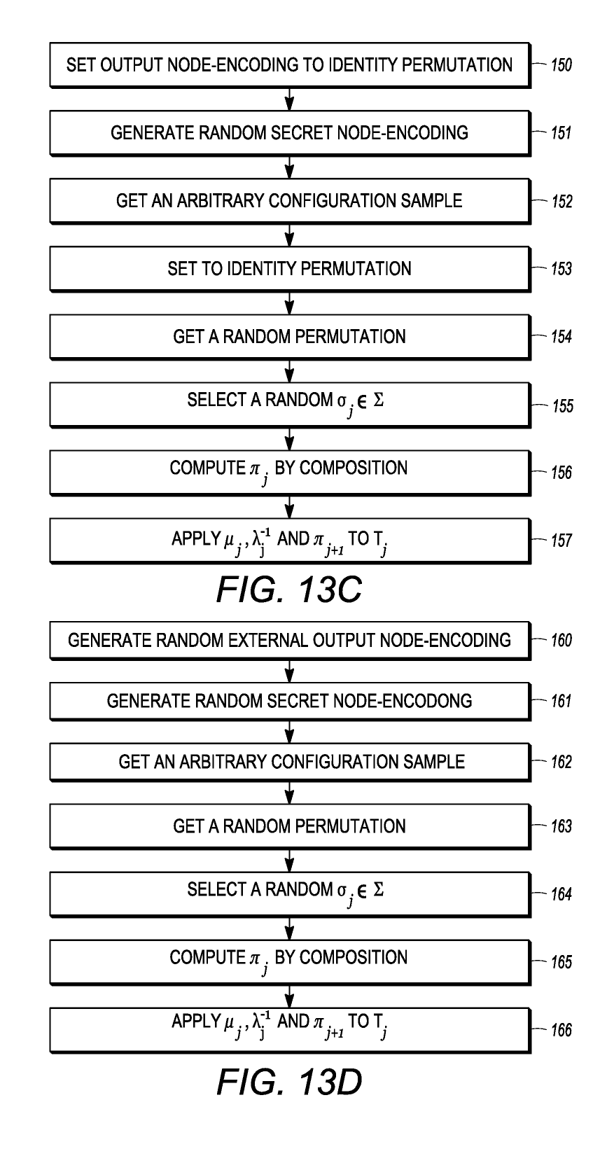

FIG. 13A shows a flow diagram of the general steps carried out by the pseudo code, and these steps are shown in the pseudo code.

2.2.6 Node-Locking Static White-Box Implementation (with Application Binding)

As described above, in another option, a static white-box implementation of original program (with application binding) is used. Referring to FIGS. 6A and 7B, the node-locking of static white-box implementation (with application binding) of the original program will be described. This generates a node-locked program (that is, (static) white-box implemented, node-locked program). The node-locked program is application bound, but is generated from a whitebox implementation without application binding, by way of example.

FIG. 6A shows in diagrammatic form the structure of the node-locking for a static white-box implementation of original program with application binding, which was described above.

Referring to FIG. 7B, the node-locked program as described above is constructed as follows. (Note, FIG. 7B shows in block-level functional form the static white-box implementation (with application binding) of the original program/original algorithm (left hand side) from FIG. 4A and in block-level functional form the resulting node-locked version of the white-box implementation of the original program/original algorithm (right hand side).

The generation process described with reference to FIG. 3, step 33, generates the right hand side from the left hand side.

Random bijections μ₁, μ₂, . . . , μₙ, π₁, . . . . , πₙ₊₁ϵS_{T} and functions σ₁, σ₂, . . . , σₙϵΣ are generated so that for each coordinate cⱼ of C and all inputs x, it holds that μⱼ (σⱼ(πⱼ(x),cⱼ))=x, where each table T₁, . . . , Tₙ is replaced (as illustrated on the right-hand-side) with node-encoded tables T′₁, . . . , T′ₙ to bind the white-box implementation to the device instance, identified by C.

Referring to the pseudocode below, the node-locked program to carry out the function as represented in FIG. 7B and described above is generated in step 33, FIG. 3, as follows. This pseudocode represents program code in the controller that is configured to carry out the process.

ALGORITHM 1 UNIFORM PPT STATIC WHITE-BOX NODE-LOCKING ALGORITHM.

| REQUIRE: {T₁,...,Tₙ}, m, n | | |
|---|---|---|
| 1: | πₙ₊₁ ← S_{T} | GENERATE RANDOM EXTERNAL OUTPUT NODE-ENCODING (140) |
| 2: | FOR EACH n ≥ j ≥ 1 DO | |
| 3: | cⱼ ← N | GET AN ARBITRARY CONFIGURATION SAMPLE (141) |
| 4: | μⱼ ← S_{T} | GET A RANDOM PERMUTATION (142) |
| 5: | σⱼ ← Σ | SELECT A RANDOM σⱼ ϵ Σ (143) |
| 6 | πⱼ⁻¹ ← μⱼ o σⱼ (cⱼ) | COMPUTE πⱼ BY COMPOSITION (144) |
| 7: | FOR EACH 1 ≤ i ≤ m DO | |
| 8: | [T′ⱼⁱ]ᵢ : = πⱼ₊₁ ([Tⱼ] μⱼ(i)) | APPLY μⱼ AND πⱼ₊₁ TO Tⱼ (145) |
| 9: | END FOR | |
| 10: | END FOR | |
| 11: | RETURN {T₁ⁱ,...,Tₙⁱ}, {σ₁,...,σₙ } , C = { c₁,...,cₙ } , π₁ , πₙ₊₁⁻¹ | |

FIG. 13B shows a flow diagram of the general steps carried out by the pseudo code, and these steps are shown in the pseudo code.

2.2.7 Node Locking Dynamic White-Box Implementation (without Application Binding)

Alternatively, a dynamic white-box implementation is used. Referring to FIG. 6B, 7C, the node-locking of dynamic white-box program (without application binding) will be described. This generates a protected program (that is, a (dynamic) white-box, node-locked program).

FIG. 6B shows in diagrammatic form the structure of the node locking for a dynamic white box implementation of an original program. A node table encoding process takes the tables T₁ to Tₙ generated as part of the white box implementation and encoded them with parameters from the device on which the node-locked program will be executed. This results in device dependent tables, which are used as the tables in the node locked white box implementation of the original program.

Referring to FIG. 7C, the node-locked program as described above is constructed as follows. (Note, FIG. 7C shows in block-level functional form the dynamic white-box implementation (without application binding) of the original program/original algorithm (left hand side) from FIG. 4B and in block-level functional form the resulting node-locked version of the white-box implementation of the original program/original algorithm (right hand side)). The generation process described with reference to FIG. 3 generates the right hand side from the left hand side.

Random bijections μ₁, . . . , μₙ, λ₁, . . . , λₙ, π₂, . . . , πₙϵS_{T} and functions σ₁, σ₂, . . . σₙϵΣ are generated to bind the white-box implementation to the device instance and the dynamic secret sᵢ″=λ(ρ(S)).

Referring to the pseudocode below, the node-locked program to carry out the function as represented in FIG. 7C and described above is generated in step 33, FIG. 3, as follows. This pseudocode represents program code in the controller that is configured to carry out the process.

ALGORITHM 2 UNIFORM PPT DYNAMIC WHITE-BOX NODE-
LOCKING ALGORITHM WITHOUT APPLICATION BINDING.

| REQUIRE: {T₁,...,Tₙ}, m, n | | |
|---|---|---|
| 1: | πₙ₊₁ ← e | SET OUTPUT NODE-ENCODING TO IDENTITY PERMUTATION (150) |
| 2: | FOR EACH n ≥ j ≥ 1 DO | |
| 3: | λⱼ← S_{T} | GENERATE RANDOM SECRET NODE-ENCODING (151) |
| 4: | cⱼ ← N | GET AN ARBITRARY CONFIGURATION SAMPLE (152) |
| 5: | IF j = 1 THEN | |
| 6: | μ₁← e | SET TO IDENTITY PERMUTATION (153) |
| 7: | ELSE | |
| 8: | μⱼ← S_{T} | GET A RANDOM PERMUTATION (154) |
| 9: | END IF | |
| 10: | σⱼ← Σ | SELECT A RANDOM σⱼ ϵ Σ (155) |
| 11: | πⱼ⁻¹← μⱼ o σⱼ (cⱼ) | COMPUTE πⱼ BY COMPOSITION (156) |
| 12: | FOR EACH 1 ≤ h ≤ m DO | |
| 13: | FOR EACH 1 ≤ i ≤ m DO | |
| 14: | [Tⱼⁱ]_{h,i} : = πⱼ₊₁ ([Tⱼ] μⱼ(h),λⱼ⁻¹ (i) ) | APPLY μⱼ, λⱼ⁻¹ AND πⱼ₊₁ TO Tⱼ (157) |
| 15: | END FOR | |
| 16: | END FOR | |
| 17: | END FOR | |
| 18: | RETURN {T₁ⁱ,...,Tₙⁱ}, {σ₁,...,σₙ } , π₁ , πₙ₊₁⁻¹ , C = { c₁ ,..., cₙ} | |
| | λ = { λ₁ ,..., λₙ } | |

FIG. 13C shows a flow diagram of the general steps carried out by the pseudo code, and these steps are shown in the pseudo code.

2.2.8 Node Locking Dynamic White-Box Implementation (with Application Binding)

Alternatively, a dynamic white-box implementation is used. Referring to FIG. 6B, 7D, the node-locking of dynamic white-box program (with application binding) will be described. This generates a protected program (that is, a (dynamic) white-box, node-locked program).

FIG. 6B shows in diagrammatic form the structure of the node locking for a dynamic white box implementation of an original program. A node table encoding process takes the tables T₁ to Tₙ generated as part of the white box implementation and encoded them with parameters from the device on which the node-locked program will be executed. This results in device dependent tables, which are used as the tables in the node locked white box implementation of the original program.

Referring to FIG. 7D, the node-locked program as described above is constructed as follows. (Note, FIG. 7D shows in block-level functional form the dynamic white-box implementation (with application binding) of the original program/original algorithm (left hand side) from FIG. 5D and in block-level functional form the resulting node-locked version of the white-box implementation of the original program/original algorithm (right hand side). The generation process described with reference to FIG. 3 generates the right hand side from the left hand side.

Referring to the left hand side of FIG. 7D, a dynamic white-box node-locking model extends the static model with an additional secret node encoding. In a dynamic white-box node-locking model, a node-id λ=(λ₁, . . . , λₙ) is generated at install-time to allow for customization of the encoded secret ρ(s) to a node-locked device. The node-id is sent to the server, which performs the encoding s″ᵢ=(λᵢ(ρ₁(s₁)), . . . . , λₙ(ρₙ(sₙ))), then sends the node-encoded secret s″ᵢ to the implementation.

FIG. 7D shows the node-encoded dynamic white-box implementation. Random bijections μ₁, . . . , μₙ, λ₁, . . . , λₙ, π₁, . . . , πₙ₊₁ϵS_{T} and functions or, σ₁, σ₂, . . . , σₙϵΣ are generated to bind the white-box implementation to the device instance, calling application instance, and the dynamic secret s″ᵢ=λ(ρ(S)).

Referring to the pseudocode below, the node-locked code to carry out the function as represented in FIG. 7D is generated as follows. This pseudocode represents program code in the controller that is configured to carry out the process.

ALGORITHM 2 UNIFORM PPT DYNAMIC WHITE-BOX
NODE-LOCKING ALGORITHM.

| REQUIRE: {T₁,...,Tₙ}, m, n | | |
|---|---|---|
| 1: | πₙ₊₁ ← S_{T} | GENERATE RANDOM EXTERNAL OUTPUT NODE-ENCODING (160) |
| 2: | FOR EACH n ≥ j ≥ 1 DO | |
| 3: | λⱼ← S_{T} | GENERATE RANDOM SECRET NODE-ENCODONG (161) |
| 4: | cⱼ← N | GET AN ARBITRARY CONFIGURATION SAMPLE(162) |
| 5: | μⱼ← S_{T} | GET A RANDOM PERMUTATION (163) |
| 6: | σⱼ← Σ | SELECT A RANDOM σⱼ ϵ Σ (164) |
| 7: | πⱼ⁻¹← μⱼ o σⱼ (cⱼ) | COMPUTE πⱼ BY COMPOSITION (165) |
| 8: | FOR EACH 1 ≤ h ≤ m DO | |
| 9: | FOR EACH 1 ≤ i ≤ m DO | |
| 10: | [Tⱼⁱ]_{h,i} : = πⱼ₊₁([Tⱼ]μⱼ(h),λⱼ⁻¹ (i) ) | APPLY μⱼ, λⱼ⁻¹ AND πⱼ₊₁ TO Tⱼ (166) |
| 11: | END FOR | |
| 12: | END FOR | |
| 13: | END FOR | |
| 14: | RETURN {T₁ⁱ,...,Tₙⁱ}, {σ₁,...,σₙ } , π₁ , πₙ₊₁⁻¹, C = {c₁,...,cₙ⁻¹ }, | |
| | λ = {λ₁,...,λₙ} | |

FIG. 13D shows a flow diagram of the general steps carried out by the pseudo code, and these steps are shown in the pseudo code.

In a white-box context, the aim of node-locking is to increase the cost of code-lifting and related attacks against a white-box implementation. In addition to identifying and lifting the code of the static white-box implementation, a code-lifting attack against a node-locked construction will include the following:

1. Identify the external encodings π₁ and πₙ₊₁⁻¹ in the calling application for every call to the white-box implementation.

2. Either of:
a. Trace attack to recover the table encodings T₁, . . . , Tₙ over all inputs; in conjunction with a crack to substitute T′₁, . . . , T′ₙ with these tables. The crack must also remove the external encodings π₁ and π⁻¹ₙ₊₁ and all functions σ₁, . . . , σₙ.
b. Lift the code for π₁ and π⁻¹ₙ₊₁ combined with a cloning attack of the device configuration information C. This attack may be expensive for a sufficiently large magnitude of the vector-space |Nⁿ|.

3. Deep analysis of the white-box implementation to avoid silent failure modes. Because a white-box implementation is a chain of dependent lookup-tables, any missed elements in the above attacks will propagate errors through the white-box. Since we are dealing with strong ciphers such as AES, even small errors (single bit differences) in encoded cryptographic keys will result in an avalanche effect that corrupts the output of the white-box in an unpredictable manner. The absence of conditional logic will further increase the cost of the attack by not leaking information about the source of the failure.

In addition to the security of static white-box node-locking, dynamic white-box node-locking also binds the encoded secret to a distinct node-locked device instance:

1. Code-lifting of a node-locked instance will necessitate the interception and injection of the node-encoded secret s″ᵢ, thus adding a layer of resilience against key-transfer attacks. This applies to all designs, including those with low implementation diversity or those without a key-ladder.

2. The secret s″i is customized to a particular device, thus allowing traceability back to the compromised implementation.

### 3. Utilization of Protected Program

Once generated, the protected program can be transferred to (or generated on) a computer system (data flow receiver) 23 for data flow processing, such as that shown in FIG. 1, 8. This is the computer system to which the protected program is node-locked. Alternatively, the node-locked (protected) program can be generated directly on the computer system on which the program will be executed. The computer system 23 executes the node-locked program such that the functionality of the embodied algorithm processes the input data flows and generates output data flows, as previously described broadly with reference to FIG. 1. Such a computer system 23 is shown generally in FIG. 8, and could also be the same computer system 10 referred to in FIG. 1. The computer system can more generally be referred to as a “device”, such as a media player.

The data flow receiver computer system 23 comprises a storage repository 70, a processor 71 that executes the node-locked program, an input interface 72 and an output interface 73. The node-locked program that has been previously generated is transferred to the computer system 23, either directly into the processor 71—e.g. at the time of manufacture, or into the storage 70 where it is later retrieved by the processor 71 when the program has to be executed. Input data streams 12 for processing by the node-locked program are received via the input interface 72 and optionally stored in the storage repository 70. Upon execution of the protected program, the input data stream 12 is received directly at the processor 71 or retrieved from the storage repository 70. The protected program executes a functionality that processes the input datastream and generates an output data stream which can then be used in further processes executed by the processor 71, or can be output via the output interface 73 to another system 75 (such as an audio-visual system).

As an example, the input data stream 12 could be an encrypted data stream embodying content which is decrypted by the node-locked program and the unencrypted data is then output for use. The node-locked program carries out a functionality that is the same as the functionality embodied in the original program code. Therefore, the output data flow generator from an input data flow is exactly the same as if the original program were used in the computer system.

### 3.1 Streaming Media Delivery System

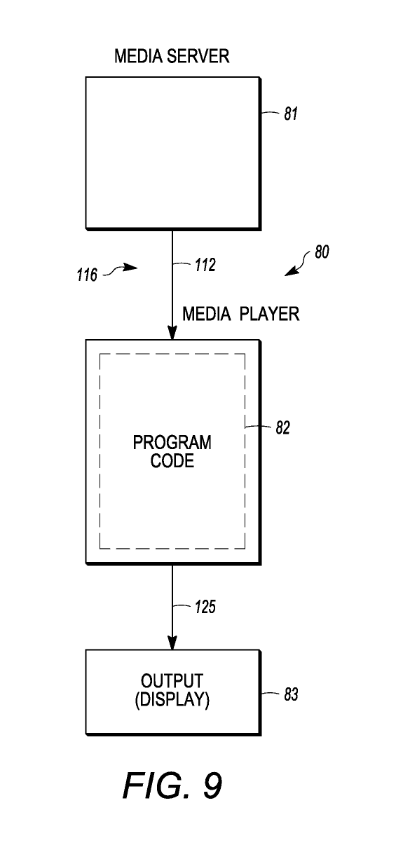

Referring to FIGS. 9 to 12, in one possible example, a node-locked program generated as described above could be used in place of the original program that provides decryption, decompression and/or decoding functionality used in media streaming delivery systems.

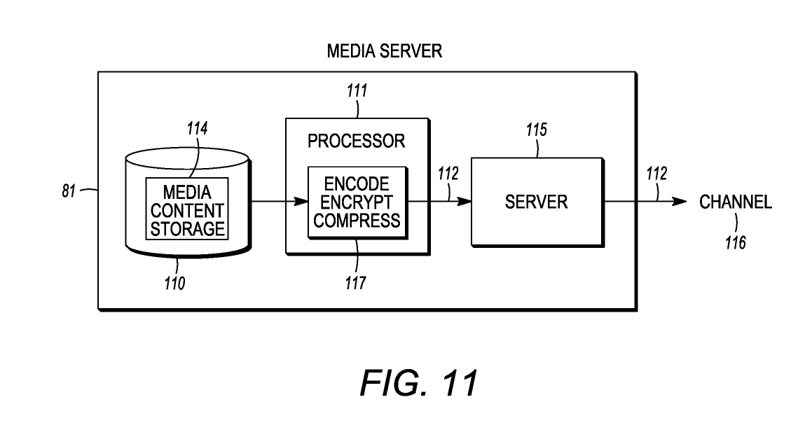

FIG. 9 shows a typical existing media streaming delivery system 80, comprising a media server 81, a media player 82 and an output 83, such as an audio-visual system (display). The media server 81 is shown generally in FIG. 11. The media server comprises a storage repository 110 with media content 114, a processor 111, which takes the media content and executes algorithms 117 to generate a media stream 112 (becoming input data stream 13) embodying the media content 114 in an encrypted and compressed form, and a server (such as a web server, broadcasting transmitter or the like) for transmitting the stream over a suitable transmission channel 116, such as an internet channel, telecommunications channel or a television broadcast transmission. The encrypted media stream is received at a media player at the end user/subscriber's location for consumption.

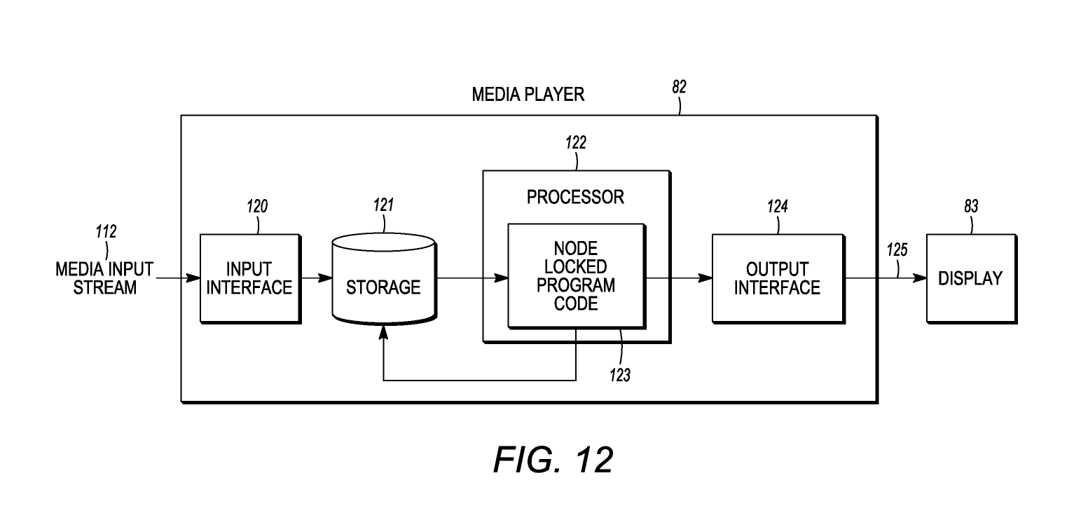

Referring to FIG. 12, the media player 82 is the data flow receiver hardware that comprises an input interface 120, data storage repository 121, processor 122 running a decryption and codec algorithm 123 and an output interface 124. The media player 82 is one example of a data flow receiver computer system 23 such as that more generally described in FIG. 8. The processor 122 receives the input media stream 112 either directly or from the data storage repository 121 and executes the algorithms 123 to decrypt and decompress the media stream 112. This results in an output media stream with the media content 125 that is then passed through the output interface 124 to the output device, which might be an audio-visual system 83 such as a television. The output device optionally might be integral with the media player 82. The output device 83 can take the unencrypted media stream and use it to display the media content to the user/subscriber.

If an unauthorized party intercepts the media stream in the transmission channel 116, they cannot easily retrieve the media content 114 and us it unless they know the decryption algorithm. However, an adversary could use code lifting and/or key recovery attacks as described previously on this type of arrangement.

3.1.1 Media Player with Protected Program that is a White-Box, Node-Locked Version of Original Program

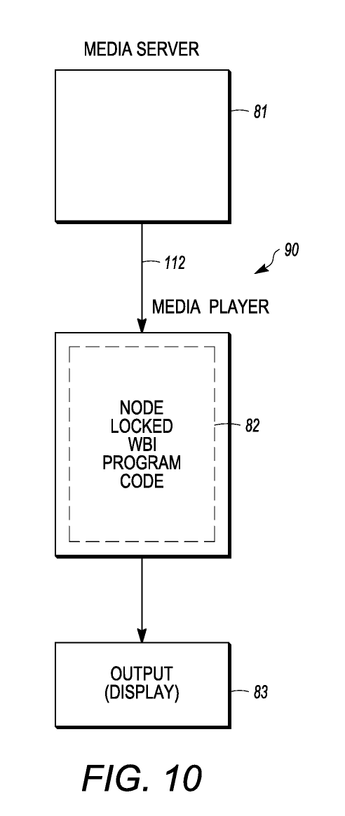

FIG. 10 shows a streaming media delivery system 90 utilizing a node-locked program embodying decryption, encoding and/or codec (decompression) algorithms. Instead of the processor 122 in the media player 82 executing the original program embodying the decryption and codec algorithms A with functionality F, the processor 122 executes the protected program, which is generated from the original program as described previously. The program is node-locked to the media player as described herein, and can only execute on that device as its execution relies on interacting with parameters specific to the media player. The media server 81 operates in the usual manner. It retrieves the media content 114, generates a media stream 112, encrypts and compresses the media stream 112 and then transmits the compressed and encrypted media stream 112 over the transmission channel 116 using a server, broadcast or other suitable transmission. The encrypted and compressed media stream 112 is received at the media player 82 in the usual manner. The media player 82 executes the protected program to implement decryption and codec functionalities F to decrypt and decompress the media stream 112, and extract the media content 114.

The media content output stream 125 is passed to the output device 83 for display of the media content. A white box implementation of original program prevents, or at least slows down, an adversary from making a key recovery attack. This is because the key is formed as part of the white box implementation of the program, or an encoded static or dynamic key is used. A white box implementation of a program can still be vulnerable to a code lifting attack. Node-locking the WBI program to a particular device prevents, or at least slows down adversary, from carrying out a code-lifting attack. In such a situation, it might still be possible for an adversary to code-lift the WBI program and the application it executes on. In this case, the option of also carrying out application binding of the WBI program to the application executes on prevents, or at least slows down, an adversary from code-lifting the WBI program with the application.

### 3.2 Other Uses for Node-Locked Programs

As noted, the above examples are one embodiment only, and there other end uses for node-locking as described. In addition to streaming media applications, the node-locking could also be used for (not limiting):

1. Document management systems, where documents are shared between authorized parties.

2. Media or software license management, where verification of licenses is required.

3. Media players in a web browser or other untrusted platform.

4. More generally, a data flow receiver that receives a stream of encrypted data and contains a program to decrypt that stream to provide unencrypted output, or any system on an untrusted platform where the program needs to protection from untrusted parties.

Although the present invention has been described above with particularity, this was merely to teach one of ordinary skill in the art how to make and use the invention. Many additional modifications will fall within the scope of the invention as that scope is defined by the following claims.

What is claimed:

1. A method of generating a protected program from an original program such that the protected program is less vulnerable than the original program to unauthorized use when installed on a device, the method comprising the steps of:
receiving, at a processor, an original program that provides a functionality, wherein the original program takes an input data flow and generates an output data flow,
in the processor:
transforming the original program into a white-box implementation of the original program comprising encoded functional blocks, and
transforming the white-box implementation of the original program into a node-locked program, by further encoding the encoded functional blocks with device specific parameters to provide node-encoded functional blocks,
wherein the node-locked program is for use on and is node-locked to the device.

2. A method according to claim 1 wherein the node-locked program is a node-locked white-box implementation of the original program.

3. A method according to claim 1 wherein the original program further takes an input key and generates the output data flow from the input data flow and the key.

4. A method according to claim 1 wherein the node-locked program is generated on a processor on the device, or is generated elsewhere for transferring, or storing for later transfer from the processor to the device.

5. A method according to claim 1 wherein the white-box implementation of the original program is a static white-box implementation of the original program.

6. A method according to claim 5 wherein the static white-box implementation of the original program is application bound to an application on the device on which the node-locked program will execute.

7. A method according to claim 1 wherein the white-box implementation of the original program is a dynamic white-box implementation of the original program.

8. A method according to claim 7 wherein the dynamic white-box implementation of the original program is application bound to an application on the device on which the node-locked program will execute.

9. A system for generating a protected program from an original program such that the protected program is less vulnerable than the original program to unauthorised use when installed on a device, the system comprising a processor for:
receiving an original program that provides a functionality, wherein the program takes an input data flow and generates an output data flow,
transforming the original program into a white-box implementation of the original program code comprising encoded functional blocks, and
transforming the white-box implementation into a node-locked program, by further encoding the encoded functional blocks with device specific parameters to provide node-encoded functional blocks,
wherein the node-locked program is for use on and is node-locked to the device.

10. A system according to claim 9 wherein the node-locked program is a node-locked white-box implementation of the original program.

11. A system according to claim 9 wherein the original program further takes an input key and generates the output data flow from the input data flow and the key.

12. A system according to claim 9 wherein the device is or forms part of the system.

13. A system according to claim 9 wherein the system is configured to transfer, or store for later transfer, the node-locked program from the processor to the device.

14. A system according to claim 9 wherein the white-box implementation of the original program is a static white-box implementation of the original program.

15. A system according to claim 14 wherein the static white-box implementation of the original program is application bound to an application on the device on which the node-locked program will execute.

16. A system according to claim 9 wherein the white-box implementation of the original program is a dynamic white-box implementation of the original program.

17. A system according to claim 16 wherein the dynamic white-box implementation of the original program is application bound to an application on the device on which the node-locked program will execute.
